(19) United States
(12) Patent Application Publication
(10) Pub. No.: US 2017/0338018 A1
(43) Pub. Date: Nov. 23, 2017

(54) TABLE PAD SECTIONS WITH MAGNETIC COUPLING SYSTEM

(71) Applicant: Lydon-Bricher Manufacturing Company, Oakdale, MN (US)

(72) Inventors: Steven D. McKay, Stillwater, MN (US); Brenda M. Tracy, Woodbury, MN (US)

(21) Appl. No.: 15/596,321

(22) Filed: May 16, 2017

Related U.S. Application Data
(60) Provisional application No. 62/337,709, filed on May 17, 2016.

(51) Int. Cl. H01F 7/02

(52) U.S. Cl. CPC H01F 7/0252

(57) ABSTRACT

A table pad assembly includes a first pad section and a second pad section. The first pad section includes a first section lip that has a first magnetic element. The second pad section includes a second section lip that has a second magnetic element. The second section lip overlaps the first section lip when the second pad section is positioned adjacent to the first pad section, and the second magnetic element overlaps the first magnetic element when the second pad section is positioned adjacent to the first pad section, such that the first and second magnetic elements cooperate to releasably couple the first and second pad sections.

### CROSS REFERENCE TO RELATED APPLICATION

The present application claims the benefit of and priority to, under 35 U.S.C. §119(e), U.S. Provisional Application Ser. No. 62/337,709, filed May 17, 2016, entitled TABLE PAD SECTIONS WITH MAGNETIC COUPLING SYSTEM, which is incorporated herein by reference in its entirety and for all purposes.

### BACKGROUND

Table pads are commonly used to protect a dining table from damage while the table is in use. Table pads may be made of a water resistant top covering (e.g., forming an upper major surface), a soft base covering (e.g., forming a lower major surface that overlays the table), and a wood fiber center section. The wood fiber center section may be composed of two or more layers of wood fiber material laminated together. For size and shipping convenience, and because many tables come with extension leaves that may or may not be used at a given time, table pads are commonly made in at least two and as many as five (or more) separate pieces or sections. Structures and methods for releasably coupling or holding the table pad sections to one another when the sections are on a table are also known. Table pads having coupling systems are disclosed, for example, in the following U.S. patents: U.S. Pat. No. 1,888,104 to Kahn, U.S. Pat. No. 2,166,837 to Ash, U.S. Pat. No. 6,165,577 to Berger, and U.S. Pat. No. 6,919,166 to Heal, all of which are incorporated herein by reference in their entireties and for all purposes.

### SUMMARY

Embodiments of the invention include table pad sections configured with structures enabling the sections to couple together when the table pad is in use on a table. The table pad sections have overlapping lips. The top portion of a table pad piece has a lip that extends past the bottom portion of the table pad and the bottom portion of the adjacent table pad piece has a lip of the same lip size that extends past the top portion of the table pad. When in use the two table pad pieces are placed together and the top portions of the two table pad pieces fit up against each other. To join and hold the table pieces together, complementary magnetic elements are placed within the lip portions of the table pads. The magnetic force in the overlapping top lip faces downward and the magnetic force in the overlapping bottom lip faces upwards thus forming a magnetic bonding to releasably couple the separate sections.

### BRIEF DESCRIPTION OF THE DRAWINGS

FIG. 1 is a top view of a table pad assembly according to embodiments of the invention.

FIG. 2 is a partial perspective view of a first pad section of the table pad assembly of FIG. 1.

FIG. 3 is a partial perspective view of a second pad section of the table pad assembly of FIG. 1.

FIG. 4A is a partial side view of the first pad section and the second pad section of the table pad assembly of FIG. 1 before coupling the sections.

FIG. 4B is a partial side view of the first pad section and the second pad section of the table pad assembly of FIG. 1 after coupling the sections.

It should be understood that the drawings are intended to facilitate understanding of exemplary embodiments of the present invention are not necessarily to scale.

### DETAILED DESCRIPTION OF EMBODIMENTS OF THE INVENTION

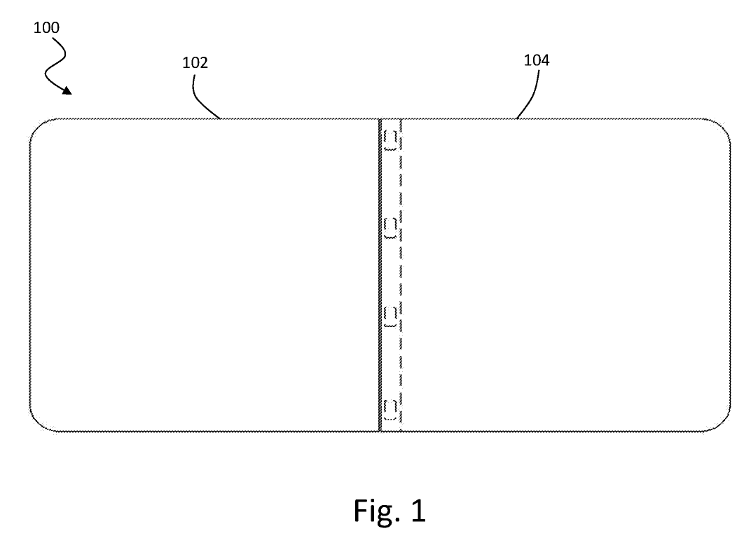

FIG. 1 illustrates a table pad assembly 100 according to embodiments of the invention. The table pad assembly 100 may be placed upon, and thereby protect, the surface of a table (not shown). Generally, the table pad assembly 100 includes a first pad section 102 and a second pad section 104. As described in further detail below, the first pad section 102 and the second pad section 104 magnetically releasably couple to each other.

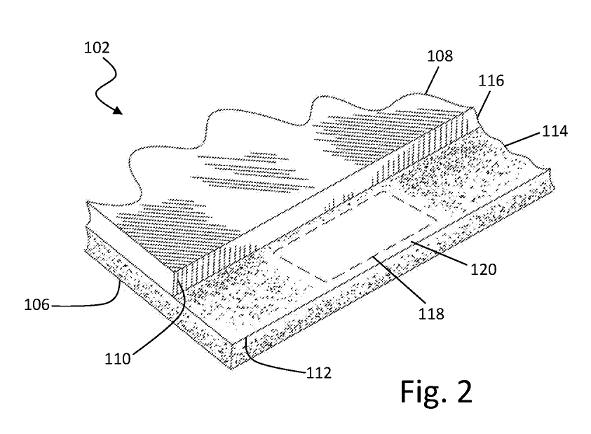

FIG. 2 illustrates the first pad section 102 of the table pad assembly 100. The first pad section 102 includes a first major surface 106, which may be referred to as a lower major surface. The first major surface 106 is configured to engage the surface of a table on which the table pad assembly 100 is placed. Opposite the first major surface 106, the first pad section 102 includes a second major surface 108, which may be referred to as an upper major surface. A first section edge portion 110 is disposed between the first major surface 106 and the second major surface 108. The first section edge portion 110 may be an elongated linear edge, and/or the first section edge portion 110 may be substantially perpendicular to the first major surface 106 and the second major surface 108. A first section lip 112 extends from the first section edge portion 110, and the first section lip 112 extends from and includes a portion of the first major surface 106 (e.g., the first section lip 112 is on the first major surface 106). The first section lip 112 may be substantially perpendicular to the first section edge portion 110, and/or the first section lip 112 may be substantially parallel to the first major surface 106 and the second major surface 108.

The first pad section 102 may be formed by a first layer 114 and a second layer 116. The first layer 114 may define the first major surface 106 and the first section lip 112. The second layer 116 may define the second major surface 108 and the first section edge portion 110. The first layer 114 and/or the second layer 116 may comprise one or more of various appropriate materials, such as wood fiber and the like. The first layer 114 and the second layer 116 may be coupled in various appropriate manners, such as via lamination.

Still referring to FIG. 2, a first magnetic element 118 is disposed on the first section lip 112 of the first pad section 102. The first magnetic element 118 may include one or more of a magnet (e.g., a permanent magnet) or an element that is attracted to a magnet (e.g., an element comprising one or more ferromagnetic materials, such as metals). As shown in the figures, the first magnetic element 118 may have a generally rectangular shape, although various other shapes may alternatively be used. For example, the first magnetic element 118 could have a generally oval shape, a generally circular shape, a generally square shape, or the like. The first magnetic element 118 may be disposed in a blind hole (not shown) formed on the first section lip 112 such that, for example, the first magnetic element 118 is flush with a surface 120 of the first section lip 112 adjacent to the first section edge portion 110. Alternatively, the first magnetic element 118 may be enclosed within the first section lip 112. In some embodiments, a plurality of first magnetic elements may be disposed on the first section lip 112. Each of the first magnetic elements may be as described above.

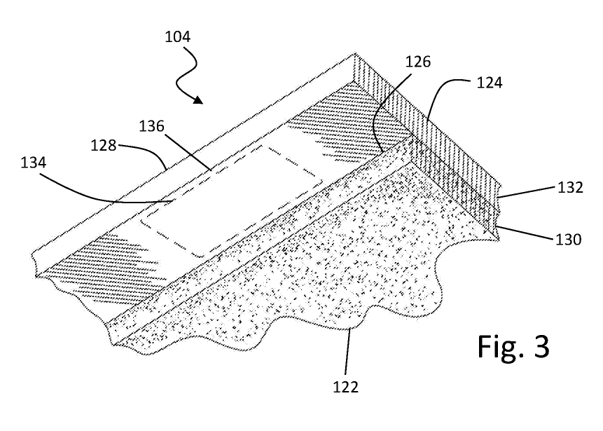

FIG. 3 illustrates the second pad section 104 of the table pad assembly 100. The second pad section 104 includes a first major surface 122, which may be referred to as a lower major surface. The first major surface 122 is configured to engage the surface of a table on which the table pad assembly 100 is placed. Opposite the first major surface 122, the second pad section 104 includes a second major surface 124, which may be referred to as an upper major surface. A second section edge portion 126 is disposed between the first major surface 122 and the second major surface 124. The second section edge portion 126 may be an elongated linear edge, and/or the second section edge portion 126 may be substantially perpendicular to the first major surface 122 and the second major surface 124. A second section lip 128 extends from the second section edge portion 126, and the second section lip 128 extends from and includes a portion of the second major surface 124 (e.g., the second section lip 128 is on the second major surface 124). The second section lip 128 may be substantially perpendicular to the second section edge portion 126, and/or the second section lip 128 may be substantially parallel to the first major surface 122 and the second major surface 124.

The second pad section 104 may be formed by a first layer 130 and a second layer 132. The first layer 130 may define the first major surface 122 and the second section edge portion 126. The second layer 132 may define the second major surface 124 and the second section lip 128. The first layer 130 and/or the second layer 132 may comprise one or more of various appropriate materials, such as wood fiber and the like. The first layer 130 and the second layer 132 may be coupled in various appropriate manners, such as via lamination.

Still referring to FIG. 3, a second magnetic element 134 is disposed on the second section lip 128 of the second pad section 104. The second magnetic element 134 is complementary to the first magnetic element 118 in regard to its material, shape, and/or position on the second section lip 128. The second magnetic element 134 may include one or more of a magnet (e.g., a permanent magnet), if the first magnetic element 118 is a magnet (provided that the magnetic poles are oriented to facilitate attraction) or an element that is attracted to a magnet, or an element that is attracted to a magnet (e.g., an element comprising one or more ferromagnetic materials, such as metals), if the first magnetic element 118 is a magnet. As shown in the figures, the second magnetic element 134 may have a generally rectangular shape, although various other shapes may alternatively be used. For example, the second magnetic element 134 could have a generally oval shape, a generally circular shape, a generally square shape, or the like. The second magnetic element 134 may be disposed in a blind hole (not shown) formed on the second section lip 128 such that, for example, the second magnetic element 134 is flush with a surface 136 of the second section lip 128 adjacent to the second section edge portion 126. Alternatively, the second magnetic element 134 may be enclosed within the second section lip 128. In some embodiments, a plurality of second magnetic elements may be disposed on the second section lip 128 (e.g., if the first pad section 102 includes a plurality of first magnetic elements). Each of the second magnetic elements may be as described above.

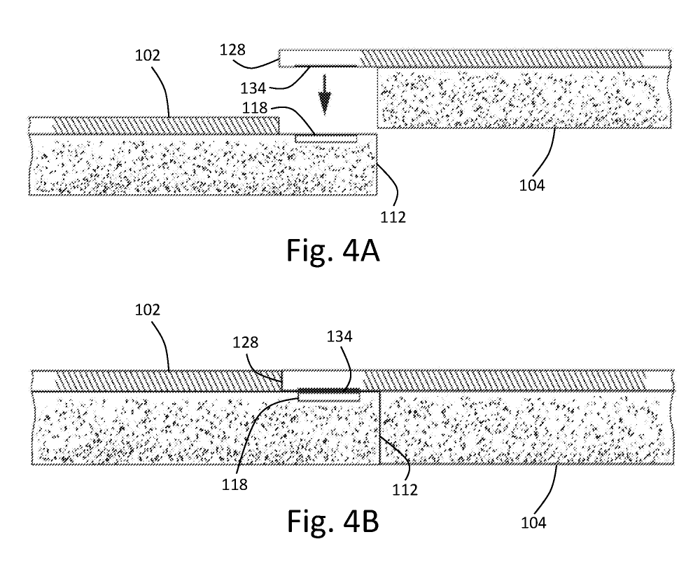

Referring now to FIGS. 4A and 4B, the second pad section 104 is configured to be positioned adjacent to the first pad section 102. More specifically, the second section lip 128 overlaps the first section lip 112, and the second magnetic element 134 overlaps the first magnetic element 118, when the second pad section 104 is positioned adjacent to the first pad section 102. As a result, one or both of the first magnetic element 118 and the second magnetic element 134 attract the other of the first magnetic element 118 and the second magnetic element 134, and the magnetic elements thereby cooperate to releasably couple the first and second pad sections 102, 104. The first and second edge portions may engage each other when the second pad section 104 is positioned adjacent the first pad section 102.

In some embodiments, one or both of the first pad section 102 and the second pad section 104 may releasably couple to one or more additional pad sections (not shown) via one or more additional lips and magnetic elements (not shown).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A table pad assembly comprising:
a first pad section including:
a first major surface;
a second major surface opposite the first major surface;
a first section edge portion between the first and second major surfaces;
a first section lip extending from the first section edge; and
a first magnetic element on the first section lip; and
a second pad section configured to be positioned adjacent to the first pad section, including:
a first major surface;
a second major surface opposite the first major surface of the second pad section;
a second section edge portion between the first and second major surfaces of the second pad section;
a second section lip extending from the second section edge, wherein the second section lip overlaps the first section lip when the second pad section is positioned adjacent to the first pad section; and
a second magnetic element on the second section lip, wherein the second magnetic element is complimentary to the first magnetic element, and overlaps the first magnetic element when the second pad section is positioned adjacent to the first pad section, such that the first and second magnetic elements cooperate to releasably couple the first and second pad sections.

2. The table pad assembly of claim 1 wherein:
the first section lip extends from and includes the first major surface of the first pad section; and
the second section lip extends from and includes the second major surface of the second pad section.

3. The table pad assembly of claim 2 wherein:
the first magnetic element includes a first magnet; and
the second magnetic element includes one or more of a second magnet or an element that is attracted to the first magnet.

4. The table pad assembly of claim 3 and further including a plurality of sets of first and second magnetic elements along the overlapping first and second section lips.

5. The table pad assembly of claim 4 wherein:
the first and second edge portions are elongated linear edges; and
the first and second elongated linear edges engage when the second pad section is positioned adjacent the first pad section.

6. The table pad assembly of claim 2 and further including a plurality of sets of first and second magnetic elements along the overlapping first and second section lips.

7. The table pad assembly of claim 2 wherein:
the first and second edge portions are elongated linear edges; and
the first and second elongated linear edges engage when the second pad section is positioned adjacent the first pad section.

8. The table pad assembly of claim 7 and further including a plurality of sets of first and second magnetic elements along the overlapping first and second section lips.

9. The table pad assembly of claim 7 wherein:
the first magnetic element includes a first magnet; and
the second magnetic element includes one or more of a second magnet or an element that is attracted to the first magnet.

10. The table pad assembly of claim 1 wherein:
the first and second edge portions are elongated linear edges; and
the first and second elongated linear edges engage when the second pad section is positioned adjacent the first pad section.

11. The table pad assembly of claim 1 wherein:
the first magnetic element includes a first magnet; and
the second magnetic element includes one or more of a second magnet or an element that is attracted to the first magnet.

12. The table pad assembly of claim 11 and further including a plurality of sets of first and second magnetic elements along the overlapping first and second section lips.

13. The table pad assembly of claim 11 wherein:
the first and second edge portions are elongated linear edges; and
the first and second elongated linear edges engage when the second pad section is positioned adjacent the first pad section.

14. The table pad assembly of claim 13 and further including a plurality of sets of first and second magnetic elements along the overlapping first and second section lips.

15. The table pad assembly of claim 1 and further including a plurality of sets of first and second magnetic elements along the overlapping first and second section lips.

16. The table pad assembly of claim 15 wherein:
the first and second edge portions are elongated linear edges; and
the first and second elongated linear edges engage when the second pad section is positioned adjacent the first pad section.

17. A pad section for a table pad assembly, the pad section comprising:
a first major surface;
a second major surface opposite the first major surface;
a section edge portion between the first and second major surfaces;
a section lip extending from the section edge, wherein the section lip is configured to overlap a section lip of another pad section when the pad section is positioned adjacent to the other pad section; and
a magnetic element on the section lip, wherein the magnetic element is complimentary to a magnetic element on the other pad section, and overlaps the magnetic element on the other pad section when the pad section is positioned adjacent to the other pad section, such that the magnetic elements cooperate to releasably couple the pad section to the other pad section.
